(19) United States
(12) Patent Application Publication
(10) Pub. No.: US 2011/0078760 A1
(43) Pub. Date: Mar. 31, 2011

(54) SECURE DIRECT MEMORY ACCESS

(75) Inventor: Hugues J.M. De Perthuis, Garcelles (FR)

(73) Assignee: NXP B.V., Eindhoven (NL)

(21) Appl. No.: 12/992,089

(22) PCT Filed: May 8, 2009
(86) PCT No.: PCT/IB09/51899

§ 371 Date: Nov. 11, 2010

(30) Foreign Application Priority Data
May 13, 2008 (EP) 08290447.5
May 8, 2009 (IB) PCT/IB2009/051899

(51) Int. Cl. G06F 12/14; G06F 17/00

(52) U.S. Cl. 726/1

(57) ABSTRACT

A data processing system comprises a memory, a memory protection unit, and one or more IP units connected to the memory via the memory protection unit. The memory protection unit is arranged to logically partition the memory into different regions, to maintain a policy for each region, the policy defining access rights to the respective region and defining the safety status of data written in the respective region, to check access requests writing data from a first region to a second region, and to refuse the access request if the safety status, according to the respective policy, of the written data in the second region is not maintained.

This invention relates to a data processing system, and to a method of operating a data processing system.

Direct memory access (DMA) is a feature of modern computers that allows certain hardware subsystems (IP units) within a computer to access system memory for reading and/or writing independently of the central processing unit (CPU). Many hardware systems use DMA including disk drive controllers, graphics cards, network cards, and sound cards. Computers that have DMA channels can transfer data to and from devices with much less CPU overhead than computers without a DMA channel. DMA is an essential feature of all modern computers, as it allows devices to transfer data without subjecting the CPU to a heavy overhead. Otherwise, the CPU would have to copy each piece of data from the source to the destination. This is typically slower than copying normal blocks of memory since access to I/O devices over a peripheral bus is generally slower than normal system RAM. During this time the CPU would be unavailable for any other tasks involving CPU bus access, although it could continue doing any work which did not require bus access.

Four pillars can be defined for platform security, authenticity, confidentiality, integrity and resilience. For each part of the system, these different aspects have to be checked. Obviously, system memory is a weak point in every system: most of the code and data are available there in the clear to every process which has DMA capabilities. Integrity of the code can be attacked by having a process overwriting part of the memory. Confidentiality can be broken by having a process accessing memory space of another process. So in conclusion, a large part of platform security relies on controlling the access to memory to ensure that a proper isolation exist between processes.

Whereas access performed by the CPU can be controlled by use of the memory management unit (MMU), assuming that software control of MMU can be trusted, currently there is no control on the DMA performed by hardware IPs, so every device driver and system peripheral can, in principle, access every memory location. For example, although a device driver is prevented from using the CPU to write to a particular page of system memory (perhaps because the page does not belong to the driver's memory space), it may instead program its hardware device to perform a DMA to the page. Thus, a compromised driver could use the DMA capability of the IP unit it controls to output the whole memory to the external world to disassembly or to overwrite code to implement another level of attack. In conclusion, as no secure DMA hardware implementation is available in an IC, it means that all drivers must be part of the trusted code base, which even if process isolation is used represents a huge number of code lines. So in conclusion, secure DMA is required to enforce isolation.

Attempts to improve DMA access security have been made. For example, United States of America Patent Application Publication US 2005/0165783 discloses a secure direct memory access through system controllers and similar hardware devices. This Patent Application describes a method and system for providing secure, direct access to computer system resources, such as system memory, by a non-trusted processing entity running in an unprivileged state that request access to the resource through a device that directly accesses the resource. The device includes access-right-checking logic and is configured to verify access rights of non-trusted processing entities that attempt to access the resource through the device. By checking access rights, the device ensures that non-trusted processing entities access only those particular portions of the resource authorized for access by the secure kernel. This system is not sufficiently flexible for many applications, as it unduly restricts the memory access.

It is therefore an aim of the invention to improve upon the known art.

According to a first aspect of the present invention, there is provided a data processing system comprising: a memory, a memory protection unit, and one or more IP units connected to the memory via the memory protection unit, wherein the memory protection unit is arranged to logically partition the memory into different regions, to maintain a policy for each region, the policy defining access rights to the respective region and defining the safety status of data written in the respective region, to check access requests writing data from a first region to a second region, and to refuse the access request if the safety status, according to the respective policy, of the written data in the second region is not maintained.

According to a second aspect of the present invention, there is provided a method of operating a data processing system comprising a memory, a memory protection unit, and one or more IP units connected to the memory via the memory protection unit, wherein the method comprises logically partitioning the memory into different regions, maintaining a policy for each region, the policy defining access rights to the respective region and defining the safety status of data written in the respective region, checking access requests writing data from a first region to a second region, and refusing the access request if the safety status, according to the respective policy, of the written data in the second region is not maintained.

Owing to the invention, it is possible to implement a more effective policy in a data processing system which allows transfer between different regions within the memory that have different security levels, as long as the necessary safety conditions are maintained. This improves the security of direct memory access, but also allows flexibility in the manner in which this is implemented.

In one embodiment, the safety status of a region may be defined in terms of encryption. For example, a specific region may have a safety status that states that data within the region must be encrypted. Therefore, if an access request moves data to this region, then this will only be allowed if the data is written into the specific region in encrypted form. The safety status could be alternatively and/or additionally be defined in terms of data compression. For example, a region may have a safety status that is defined as “uncompressed”. In this case all data within this region must be in uncompressed format. If a data request attempts to write the original compressed video sequence to this region, then this will be refused by the memory protection unit, as this will be contrary to the safety status of the specific region, which only allows uncompressed data in the respective memory region.

Preferably, the memory protection unit is further arranged to access a streaming graph of an application, and to compare access requests against the streaming graph. The use of a streaming graph has a number of advantages in maintaining the security of the direct memory accesses. Primarily this allows the memory protection unit to create the policies linked to software, and thus avoid having a static table configured at boot time.

For example, in a data processing system that further comprises a central processing unit connected to the memory via the memory protection unit, the memory protection unit is advantageously further arranged to check any allocation of memory to an IP unit, by the central processing unit, against the streaming graph. This improves the security of the overall system.

Ideally the memory protection unit is arranged to maintain a policy for a region that comprises different access rights for different IP units. This provides the greatest operational flexibility. The maintained policy for an IP unit for a region can comprise one of no access, read only, read and write, or execute.

Embodiments of the present invention will now be described, by way of example only, with reference to the accompanying drawings, in which:—

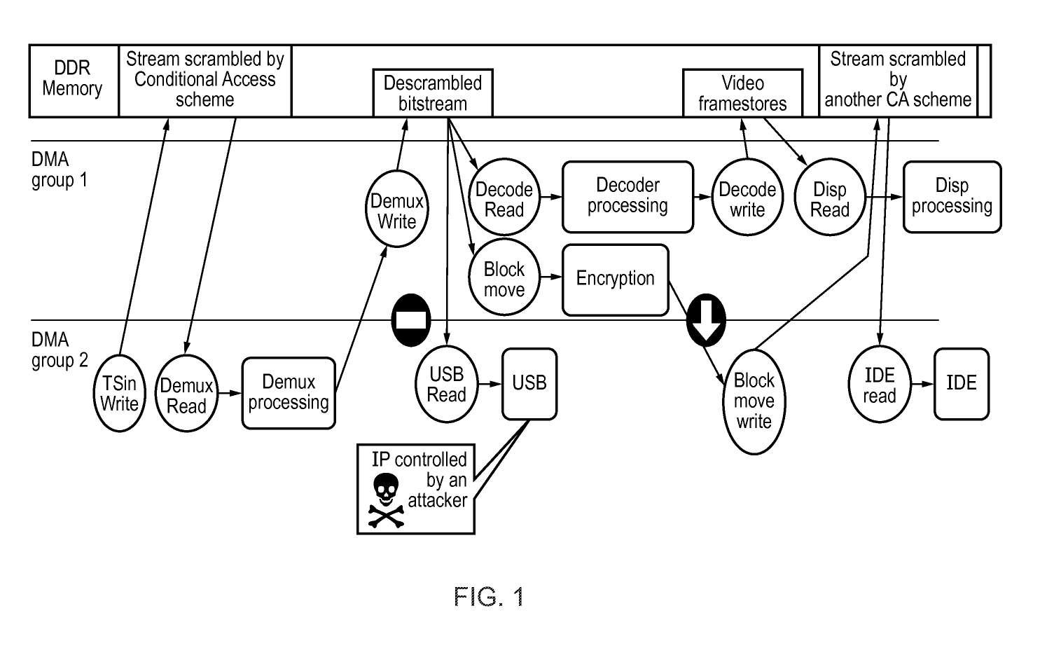

FIG. 1 is a schematic diagram of a partitioned memory,

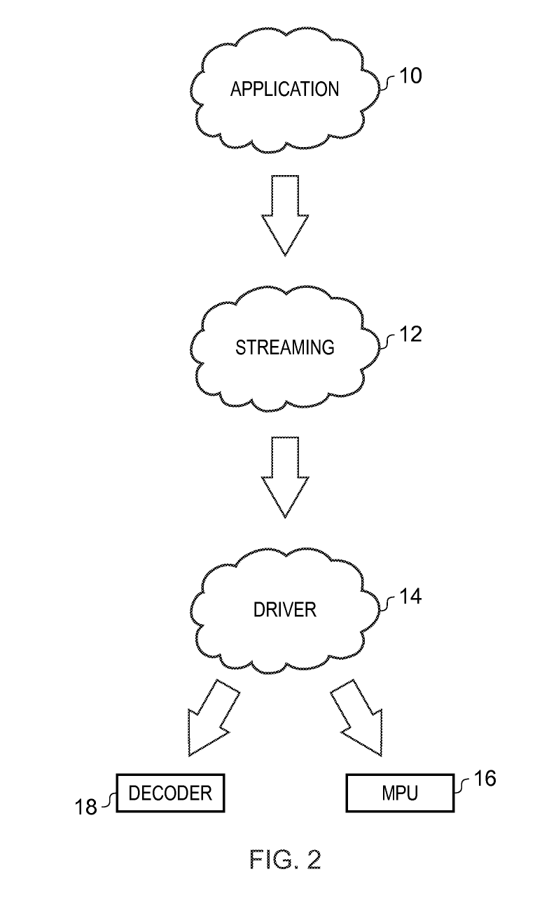

FIG. 2 is a schematic diagram of data processing,

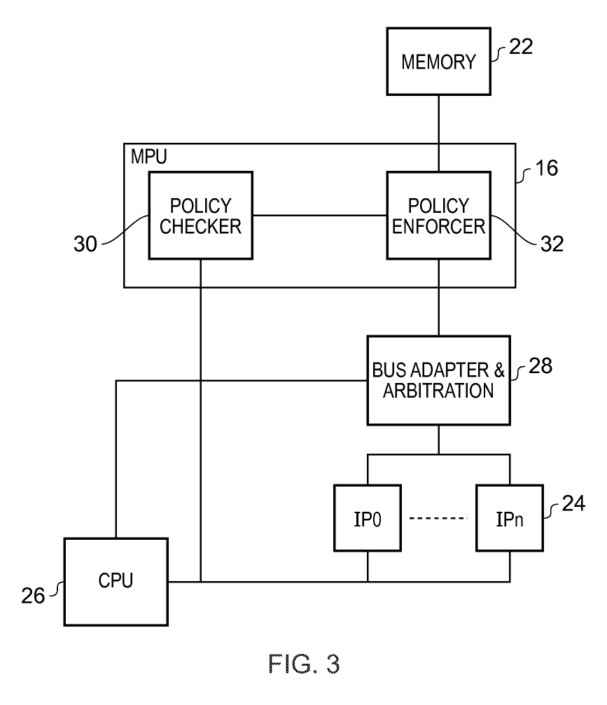

FIG. 3 is a schematic diagram of a data processing system,

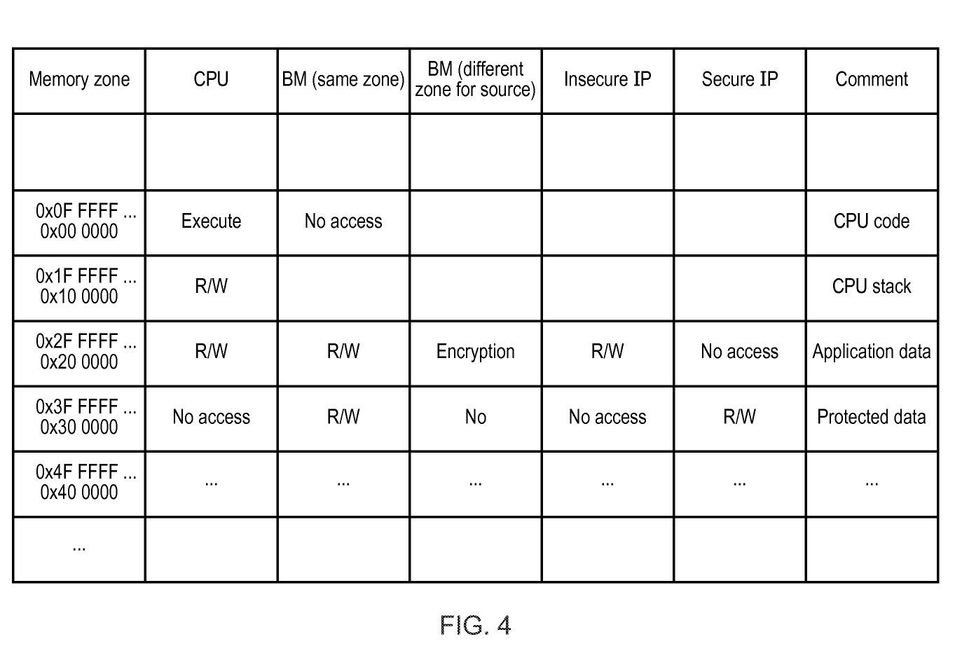

FIG. 4 is a diagram of a table, and

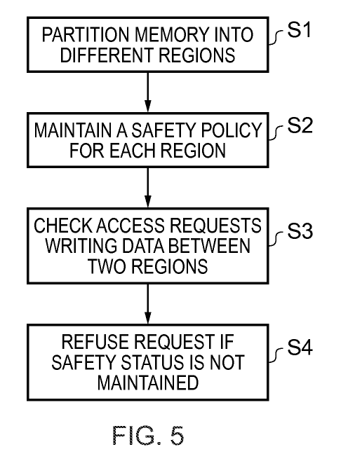

FIG. 5 is a flowchart of a method of operating the data processing system.

In general, two kinds of DMA access are performed by IP units, access for internal processing by IP units, directly from the zone allocated and a block move (possibly with some processing) from one part of memory to another. These requirements are implemented in a scenario such as described in FIG. 1. This Figure shows memory usage of a memory that is included in a set-top-box (a digital to analogue converter that is used to allow an existing analogue television access to a new digital television service). This is the type of application that needs secure DMA access, because broadcasters have high security requirements that their broadcasts (for example films and live sports broadcasts) are not pirated by end users.

In this set-top-box application example, two regions are defined in memory for use by IP units. A first region, labelled DMA group 1 includes all sensitive data such as decrypted bitstreams and decoded video. A second region, labelled DMA group 2 includes all non sensitive data such as encrypted data and HDD data, for example. Encrypted data is received from the broadcast channel and written in memory (DMA group 2) in a non protected area. This data is then read back and decrypted. As decryption now makes the data sensitive, it is written in the protected DMA region 1. This region can only be accessed by a few IP units. If an IP units such as those connected by USB or IDE try to access the sensitive data, their access should be rejected as they do not belong to the correct group. Video decoder and display units, which are part of the correct group, will have access to the bitstream and resulting image.

In some case, it is required to transfer data from the sensitive domain to the unprotected domain. In this example, bitstreams have to be read and encrypted to be stored on the HDD. For this, the block move unit will be used with encryption, so its access can be allowed. However if the block move unit was used without encryption, then access should be rejected.

In conclusion, the following requirements should be fulfilled, with different regions being defined in memory space, and each IP unit having one of the following access rights for each region, either no access, read only, read/write, or execute (for CPU only). Preferably the system should be configured so that there is the access right for each IP unit could have a different policy. These policies could vary from simple static one, for example that IP units connected by USB are not allowed to access to sensitive zone, to more complex ones, such as a block move can transfer from sensitive to unprotected zone, only if encryption is active, otherwise only block move inside the same zone are allowed. Ideally, the design of the memory and memory access should fit in advanced software architecture (i.e. Linux), where no fixed mapping is used but where process have memory dynamically allocated, discarded and reallocated.

Additional requirements can be added to the implementation. For example, it is advantageous to have a limited trusted code base, because in most of the systems, software running on the CPU cannot be trusted, so the trusted coded base is limited to boot code. In others systems, a security hypervisor is available, but nevertheless, it should be assumed that trusted coded base will be limited to a few components and cannot include large part of the software base.

Additionally, the changes to the system to make the DMA accesses more secure must have negligible performance impact. In many systems, most of the accesses are direct memory accesses performed by IP units. The impact of the process isolation on the performance should be negligible. The implementation should have a limited hardware base because most of IP units are reused, ideally the solution should be implemented outside of the IP units to avoid complex modification and qualification. Also if the hardware base is small and concentred in a single area, it is easier to implement and validate.

In order to achieve memory separation, the data processing system implements a memory management unit for input and output to the memory, i.e. by providing a memory protection unit. This unit is similarly to memory management unit used by the CPU, and it will enforce separation of tasks, but it will not perform address mapping. FIG. 2 shows how the memory protection unit will be inserted in the software architecture of the system, in the embodiment of a set-top-box.

An application 10 decides to start the decoding of a stream. The application 10 send a decode command to a streaming layer 12. The streaming layer 12 reserves buffers in memory and sends commands to drivers 14 with pointers to buffers to be used. The drivers 14 set up hardware IP units, such as the decoder 18, with the correct register values, including multiple pointers in memory. Additionally, the drivers 14 will send the same information to the memory protection unit 16, so that the memory protection unit 16 is synchronized with hardware IP units.

The memory protection unit 16 has the following roles, to check memory allocation and to check memory access. Each time, a memory zone is allocated to a hardware IP unit, the memory protection unit 16 will check that the IP unit is compatible with the current memory allocation and the policies of the system, i.e. that the memory allocated to the IP unit does not conflict to previous ones. If the request is accepted, then internal state will be updated. For each memory access performed by an IP, the memory protection unit 16 will check it is allowed.

The memory protection unit 16 will be inserted as shown in FIG. 3 in the system 20. The data processing system 20 comprises a memory 22, the memory protection unit 16, and one or more IP units 24 connected to the memory 22 via the memory protection unit 16. The memory protection unit 16 is inserted between the memory 22 and a DMA bus of the units to be controlled (here a CPU 26 and the IP units 24 with DMA capabilities). In the example embodiment shown, the memory protection unit 16 is inserted after a bus adapter 28 but could be located before.

The memory protection unit 16 contains two main units, a policy checker 30 and a policy enforcer 32. The policy checker 30 operates such that each time the CPU 26 allocates a zone in the memory 22 to a DMA unit, the CPU 26 will send a request to the memory protection unit 16. The policy checker 30 will compare this request against the policy of the system. Typically, a request will include the following information, region selected and access type (whether read, write, execute, complex operation). The request will be interpreted and the policy enforcement unit updated accordingly. The rate of request of the CPU 26 will be relatively low, as in most cases this will happen only at unit initialisation or each time a new use case starts.

The policy enforcer 32 is configured to operate so that each time an IP unit 24 performs a DMA access, the access will have to go through the policy enforcer 32. The enforcer 32 will compute which memory zone is targeted by the access and apply the policy decided by the policy checker 30, for example, by checking a table. As this unit 32 will receive a request for each DMA transaction, i.e. tens of millions per second, the processing carried out by this unit will have to be fast.

A typical processing will occur, for example, after reset, the system will boot up. While a trusted code base is still available, the policy of the system will be loaded into the policy checker unit 30. Examples of policies could be as follows:

Area allocated to a group can only be accessed by the same group,

Area allocated to group 2 can be accessed by anyone,

Area allocated to group 1 can be accessed by block moves if encryption is performed,

When a memory zone allocated to group 1 is discarded, it should be reinitialised

As it can be seen, in this description, there is an increasing priority order, i.e. a policy will override the previous ones. At start-up, the memory 22 will be allocated by default so that the main CPU 26 can have access to its code and required data zone, whereas IP units 24 on the other hand have no access to the memory 22. It is also desirable, that at boot all memory is overwritten. This is to protect against the situation, that if some sensitive data exists in memory, the chip could be reset and then used to download the content of memory before it is protected.

When software will allocate memory for a task, it will program the IP unit 24 to perform it DMA access and additionally to the usual register programming, the driver will have to declare to the memory protection unit 16 the involved DMA channels, the memory zone, and possibly additional information. The memory protection unit 16 will handle the request and check the policy. If the region requested is already being used by some other IP units 24 and that the policy forbids them to share memory, the request will be rejected and the software will have to handle that, either by allocating a new part of memory or by de-allocating the region to the other IP units 24. If the request is accepted, the policy enforcement table will be updated. An example of such as table is shown in FIG. 4.

This FIG. 4 shows an enforcement table, which defines different policies for different regions within the memory 22. In the first column is an address range, which defines the regions within the memory 22. The second column indicates the access rights of the CPU 26 to the specific region, with R/W meaning that read and write access is allowed. The next two columns refer to the status of block moves either within or between different zones of the memory. Columns five and six refer to the access rights of IP units 24 to the respective region.

The address of a direct memory access will be checked against the memory range and the ID of the IP unit 24 that is making the DMA. In the case of a transfer from a block move unit, other data (like the operation performed and the source and destination of the access) are required. If it is seen that an IP unit 24 tries to access a memory location it is not allowed to access, then the access will be refused and an interrupt will be raised.

When an IP unit 24 is no longer used, or reset, its drivers will have to also inform the memory protection unit 16 that the memory allocated to that IP unit 24 is no longer used, so that it can be reclaimed. For additional security, when reclaiming a memory location, then the operation of the memory protection unit 16 might require the specific memory to be overwritten, if it is defined as being secure. As the memory protection unit 16 sees all access, it is relatively easy to check that a whole memory range has been overwritten.

FIG. 5 summarises the method of operating the data processing system. The memory protection unit 16 is arranged, firstly, at step S1, to logically partition the memory 22 into different regions, and, at step S2, to maintain a policy for each region, the policy defining access rights to the respective region and defining the safety status of data written in the respective region. The table of FIG. 4 defines the safety status in terms of the encryption status of the data written in a particularly region by the treatment of the block moves.

The memory protection unit 16 is further arranged, at step S3 to check access requests writing data from a first region to a second region, and at step S4 to refuse the access request if the safety status, according to the respective policy, of the written data in the second region is not maintained. The memory protection unit 16 will only allow data to be written from one region to another if the safety status of the data is maintained, according to the defined safety status of the target region. This allows IP units 24 to move data around the memory 22, but maintains security of DMA access, as data that is required to be kept secure, such as a decoded broadcast stream can never be moved to an unsecure area without the encryption status being maintained. Likewise, if the safety policy is described in terms of compression, then the memory protection unit 16 only allow memory access requests that maintain the necessary compression conditions of the target memory region.

The implementation of the memory protection unit 16 can be a combination of hardware and software. The implementation of the policy checker 30 will depend much on the overall system. For instance, if there is a security processor available, the policy checker 30 can be implemented in software. If none is available, it will have to be done using hardware state machine. Obviously, the complexity of the policies to enforce will also be important. A simple one can be done in hardware, a complex one will require much more design effort. Ideally, the implementation of the policy enforcer 32 will be hardware based. Indeed as mentioned earlier, it has to support millions of transaction per second. To apply efficiently policy, the enforcement table for a given location in memory will be accessible in a few cycles. Obviously the number of regions in the memory, as well as their alignment will determine the size of this unit 32.

The memory protection unit 16 can be further arranged to access a streaming graph of an application, and to compare access requests against the streaming graph. The CPU 26, which is connected to the memory 22 via the memory protection unit 16, will allocate memory during the running of the application. In this case, memory protection unit 16 is further arranged to check any allocation of memory to an IP unit, by the CPU 26, against the streaming graph. This improves the security provided by the memory protection unit 16, as in addition to the active monitoring of DMA accesses by IP units 24, the memory protection unit 16 will also watch actual allocation of memory to the IP units 24, and if this does not fit with the streaming graph of the application, then they will be refused. This prevents any software hijacking of the CPU 26, which could used to allocate memory in a secure region to an IP unit 24 that is going to perform a pirate operation.

1. A data processing system comprising:
a memory:
a memory protection unit: and
at least one IP unit connected to the memory via the memory protection unit,
wherein the memory protection unit is arranged to logically partition the memory into different regions,
to maintain a policy for each region, the policy defining access rights to the respective regions and defining the safety status of data written in the respective regions,
to check access requests writing data from a first region to a second region, and
to refuse the access request if the safety status, according to the respective policy, of the written data in the second region is not maintained.

2. A system according to claim 1, wherein the memory protection unit is further arranged to access a streaming graph of an application, and to compare access requests against the streaming graph.

3. A system according to claim 2, further comprising a central processing unit connected to the memory via the memory protection unit, wherein memory protection unit is further arranged to check any allocation of memory to an IP unit, by the central processing unit, against the streaming graph.

4. A system according to claim 1, wherein the memory protection unit is arranged to maintain a policy for a region that comprises different access rights for different IP units.

5. A system according to claim 4, wherein the maintained policy for an

6. A method of operating a data processing system having a memory, a memory protection unit, and at least one IP unit connected to the memory via the memory protection unit, the method comprising:
logically partitioning the memory into different regions,
maintaining a policy for each region, the policy defining access rights to the respective regions and defining the safety status of data written in the respective regions,
checking access requests writing data from a first region to a second region, and
refusing the access request if the safety status, according to the respective policy, of the written data in the second region is not maintained.

7. A method according to claim 6, further comprising accessing a streaming graph of an application, and comparing access requests against the streaming graph.

8. A method according to claim 7, wherein the system further comprises a central processing unit connected to the memory via the memory protection unit, and the method further comprises checking any allocation of memory to an IP unit, by the central processing unit, against the streaming graph.

9. A method according to claim 6, wherein the step of maintaining a policy for each region comprises maintaining a policy for a region that comprises different access rights for different IP units.

10. A method according to claim 9, wherein the maintained policy for an IP unit for a region is one of no access, read only, read and write, or execute.
